(19) United States
(12) Patent Application Publication
(10) Pub. No.: US 2011/0222209 A1
(43) Pub. Date: Sep. 15, 2011

(54) CAPACITOR ELECTRODE BODY, CAPACITOR, CAPACITOR ELECTRODE BODY PRODUCING METHOD, AND CAPACITOR PRODUCING METHOD

(75) Inventor: Tatsushi Ohyama, Gifu (JP)

(73) Assignee: Sanyo Electric Co., Ltd., Moriguchi-City (JP)

(21) Appl. No.: 13/129,978

(22) PCT Filed: Nov. 10, 2009
(86) PCT No.: PCT/JP2009/005970

§ 371 Date: May 18, 2011

(30) Foreign Application Priority Data
Nov. 19, 2008 (JP) 2008-296076
Nov. 19, 2008 (JP) 2008-296077

(51) Int. Cl. H01G 9/042; H01G 7/00

(52) U.S. Cl. 361/523; 29/25.41

(57) ABSTRACT

A capacitor electrode body producing method includes forming a porous layer on a surface of a positive electrode base material by spraying a metallic particle made of tantalum (Ta) and an organic particle onto the positive electrode base material made of a tantalum foil, thereby forming a porous positive electrode body including the positive electrode base material and the porous layer.

This application is a National Stage Application of PCT/JP2009/005970 filed on Nov. 10, 2009 and claims foreign priority of Japanese Patent Application Number 2008-296076 filed Nov. 19, 2008 and Japanese Patent Application Number 2008-296077 filed Nov. 19, 2008.

### BACKGROUND OF THE INVENTION

1. Field of the Invention

The present invention relates to a capacitor electrode body, a capacitor, a capacitor electrode body producing method, and a capacitor producing method.

2. Description of the Related Art

With miniaturization and high performance of electronic devices typified by a personal computer and a mobile phone, there is an increasing demand for miniaturization, speed enhancement, and high integration in electronic circuits mounted on the electronic devices. The same holds true for passive components constituting the electronic circuit. For example, in capacitors, there is a demand for low profile and large capacity as much as possible.

Generally a solid electrolytic capacitor in which a dielectric layer made of metal oxide is formed on a surface of a positive electrode body is well known as the capacitor having a large electrostatic capacity per volume. The positive electrode body is made of a porous pellet which is obtained by performing pressure forming and burning of powders of a valve metal such as aluminum (Al), tantalum (Ta), niobium (Nb), and titanium (Ti). The valve metal has a rectifying action, and anode oxidation can be performed to the valve metal (for example, see Japanese Patent Application Laid-Open Nos. 2003-257787 and 2006-269693). The positive electrode body having an immense surface area is obtained by utilizing a submicron-level powder as the powder used, whereby the large capacity of the capacitor can be achieved.

### PRIOR ART DOCUMENTS

### Patent Documents

Patent Document 1: Japanese Patent Application Laid-Open No. 2003-257787
Patent Document 2: Japanese Patent Application Laid-Open No. 2006-269693

### SUMMARY OF THE INVENTION

Recently, with further miniaturization of electronic devices, there is a demand for large capacity in capacitors mounted on the electronic devices. The inventor recognizes that there is a still room for improvement in the solid electrolytic capacitor having the conventional structure in order to satisfy the demand for further large capacity in the capacitor.

A general purpose of the invention is to provide a technology of achieving the further large capacity of the capacitor.

In accordance with an aspect of the invention, a capacitor electrode body producing method includes forming a porous electrode body by spraying an organic particle and a metallic particle made of at least one of a valve metal and an alloy thereof onto a base material made of at least one of the valve metal and the alloy thereof.

In accordance with another embodiment of the invention, a capacitor producing method includes: preparing the capacitor electrode body formed by the producing method of the embodiment as a positive electrode body; oxidizing a surface of the positive electrode body to form a dielectric layer; and forming a negative electrode body such that a surface of the dielectric layer is covered therewith.

In accordance with still another embodiment of the invention, a capacitor electrode body includes: a base material which is made of a conductive material; and a porous layer which is provided on the base material to include at least each one of a dense layer and a scattered layer, the dense layer including a metallic grain aggregate made of at least one of a valve metal and an alloy thereof, the scattered layer including the metallic grain aggregate made of at least one of the valve metal and the alloy thereof, the scattered layer having a void ratio higher than that of the dense layer.

In accordance with still another embodiment of the invention, a capacitor includes: a positive electrode body which includes the capacitor electrode body of the embodiment; a dielectric layer which is formed on a surface of the positive electrode body; and a negative electrode body which is formed such that a surface of the dielectric layer is covered therewith.

In accordance with still another embodiment of the invention, a capacitor electrode body producing method includes providing a porous layer including a metallic grain aggregate made of at least one of a valve metal and an alloy thereof onto a base material made of a conductive material to form an electrode body, wherein a dense layer having a relatively low void ratio and a scattered layer having a relatively high void ratio are stacked to form the porous layer in the electrode body forming step.

According to the invention, the further large capacity of the capacitor can be achieved.

### BRIEF DESCRIPTION OF THE DRAWINGS

FIG. 1 is a schematic sectional view illustrating a configuration of a capacitor produced by a capacitor producing method according to a first embodiment of the invention;

FIGS. 2A to 2D are process sectional views illustrating the capacitor producing method of the first embodiment;

FIGS. 3A to 3C are process sectional views illustrating the capacitor producing method of the first embodiment;

FIG. 4 is a schematic view of a cold spray apparatus;

FIG. 5 is a process sectional view illustrating a capacitor producing method according to a second embodiment of the invention;

FIGS. 6A to 6C are process sectional views illustrating a capacitor producing method according to a third embodiment of the invention;

FIGS. 7A and 7B are process sectional views illustrating a capacitor producing method according to a fourth embodiment of the invention;

FIG. 8 is a process sectional view illustrating a capacitor producing method according to a fifth embodiment of the invention;

FIG. 9 is a process sectional view illustrating a configuration of a capacitor according to a sixth embodiment of the invention;

FIGS. 10A to 10C are process sectional views illustrating a capacitor producing method of the sixth embodiment;

FIGS. 11A to 11C are process sectional views illustrating a capacitor producing method of the sixth embodiment;

FIG. 12 is a schematic view of a cold spray apparatus;

FIGS. 13A to 13C are process sectional views illustrating a capacitor producing method according to a seventh embodiment of the invention;

FIG. 14 is a process sectional view illustrating a configuration of a capacitor according to an eighth embodiment of the invention;

FIG. 15 is a schematic sectional view illustrating a configuration of a positive electrode body according to a ninth embodiment of the invention;

FIGS. 16A and 16B are schematic sectional views illustrating a configuration of a positive electrode body according to a modification of the ninth embodiment;

FIG. 17 is a schematic sectional view illustrating a configuration of a positive electrode body according to a tenth embodiment of the invention; and

FIG. 18A is a schematic sectional view illustrating a simulation model according to an example, and FIG. 18B is a schematic sectional view illustrating a simulation model according to a conventional example.

### DETAILED DESCRIPTION OF THE EMBODIMENTS

Hereinafter, embodiments of the invention will be described with reference to the drawings. The same or equivalent component, member, and process illustrated in each drawing are designated by the same numerals, and the overlapping description will not be repeated as appropriate. The invention is not limited to the embodiments, but the embodiments are described only by way of example. All the features and a combination thereof are not always essential to the invention.

### First Embodiment

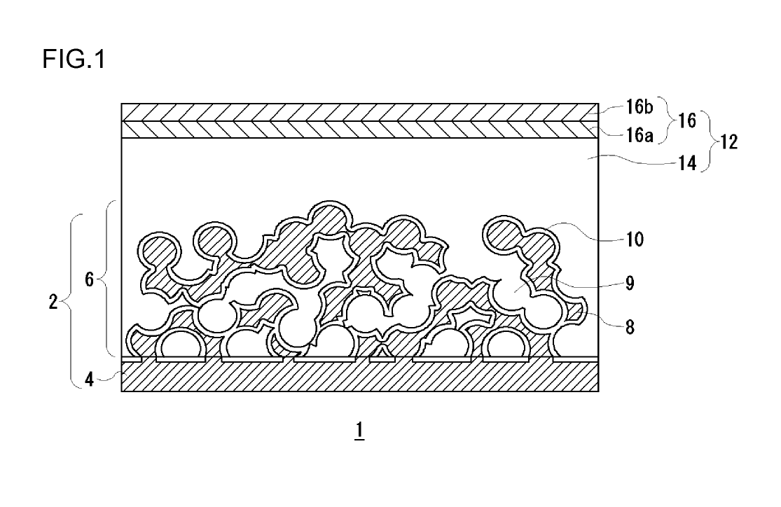

FIG. 1 is a schematic sectional view illustrating a configuration of a capacitor produced by a capacitor producing method according to a first embodiment of the invention. A capacitor 1 of the first embodiment includes a positive electrode body 2, a dielectric layer 10 which is formed on a surface of the positive electrode body 2, and a negative electrode body 12 which is formed across the dielectric layer 10 from the positive electrode body 2.

The positive electrode body 2 includes a positive electrode base material 4 (corresponding to the base material of the invention) which is made of at least one of a valve metal and an alloy thereof and a porous layer 6 which is provided on the positive electrode base material 4. The porous layer 6 includes a metallic grain aggregate in which metallic particles 8 made of at least one of the valve metal and the alloy thereof are coupled. The porous layer 6 includes plural gaps 9, and the coupled metallic particles 8 form a network. The positive electrode base material 4 includes a thin film (foil), a lead wire, and a film-shaped structure in which plural metallic particles 8 are coupled. An extraction positive electrode terminal (not illustrated) is connected to the positive electrode base material 4. For example, the positive electrode base material 4 has a thickness of about 100 μm when the positive electrode base material 4 is a metallic thin film. For example, the porous layer 6 has a thickness of about 500 μm, and the metallic particle 8 has a diameter of about 500 nm to about 50 μm.

As used herein, the valve metal means a metal in which an extremely dense dielectric oxide coating having durability can be formed on a surface thereof by an electrolytic oxidation treatment (anode oxidation). Examples of the valve metal include tantalum (Ta), niobium (Nb), titanium (Ti), and aluminum (Al). Examples of the alloy of the valve metal include an alloy of valve metals and an alloy of the valve metal and another metal. In the first embodiment, Ta is used as the metals for the positive electrode base material 4 and the metallic particle 8. Alternatively, the positive electrode base material 4 and the metallic particle 8 may be made of different metals.

The dielectric layer 10 is the oxide coating which is formed on the surface of the positive electrode body 2 by, for example, an electrolytic formation treatment. The dielectric layer 10 is formed on the surface where the positive electrode base material 4 and the porous layer 6 are exposed, namely, a region except a region where the metallic particles 8 or the metallic particle 8 and the positive electrode base material 4 come into contact with each other.

The negative electrode body 12 includes a conductive polymer layer 14 and a negative electrode base material 16 which is stacked on the conductive polymer layer 14. The conductive polymer layer 14 acts as an electrolytic layer. There is not particular limitation to the conductive polymer layer 14 as long as the conductive polymer layer 14 contains a polymer material having conductivity. For example, conductive polymers such as polythiophene, polypyrrole, and polyaniline and materials such as a TCNQ (7,7,8,8-tetracyanoquinodimethane) complex salt are suitably used as the conductive polymer layer 14. The negative electrode base material 16 includes a carbon paste layer 16a which is stacked on the conductive polymer layer 14 and a silver paste layer 16b which is stacked on the carbon paste layer 16a. An extraction negative electrode terminal (not illustrated) is connected to the negative electrode base material 16.

(Capacitor Electrode Body Producing Method and Capacitor Producing Method)

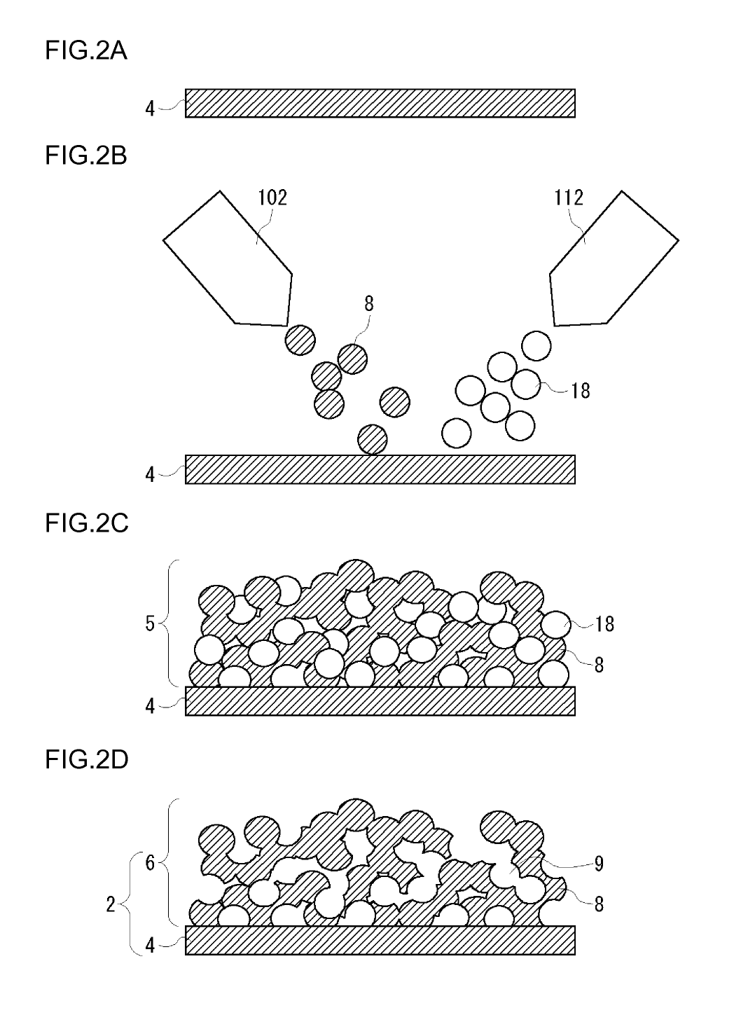

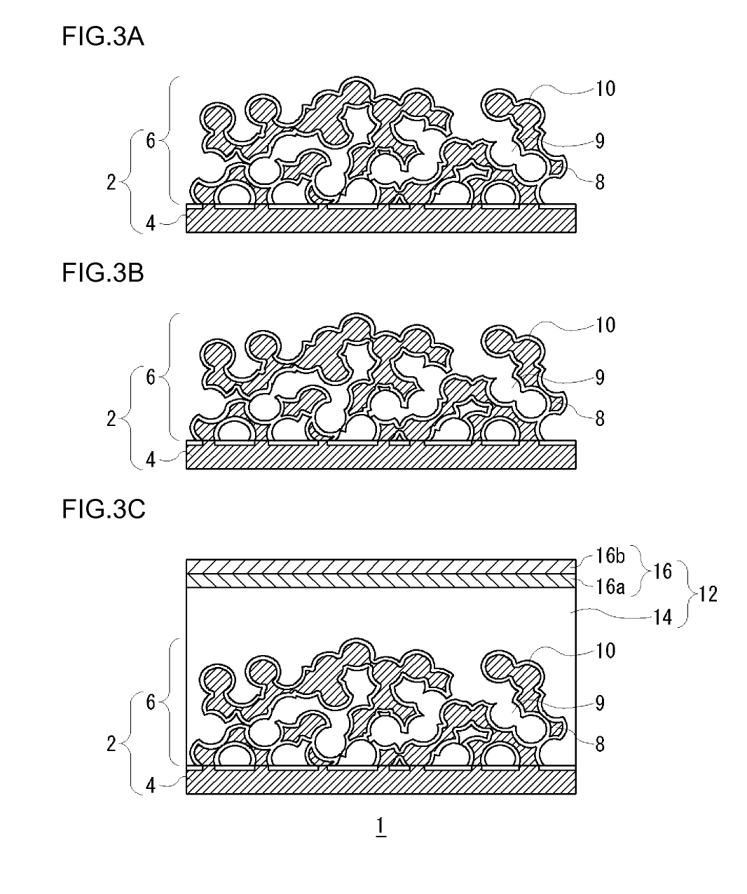

Then a method of producing the capacitor 1 of the first embodiment will be described with reference to FIGS. 2A to 2D and 3A to 3C. FIGS. 2A to 2D and FIGS. 3A to 3C are process sectional views illustrating the capacitor producing method of the first embodiment.

First the positive electrode base material 4 made of a tantalum foil which is the valve metal is prepared as illustrated in FIG. 2A.

Then, as illustrated in FIG. 2B, the metallic particles 8 made of Ta and organic particles 18 are sprayed onto the surface of the positive electrode base material 4. The organic particle 18 is an organic material having a melting point of room temperature or more. Examples of the organic particle 18 include conductive polymers such as polypyrrole and polythiophene and organic semiconductors such as a TCNQ complex salt. Preferably an organic material has a boiling point of at least a temperature raised by collision energy using a cold spray method.

In the first embodiment, the metallic particles 8 and the organic particles 18 are sprayed onto the positive electrode base material 4 by the cold spray method. The cold spray method is a processing method of causing material particles or material powders to flow at high temperature and high speed, spraying the material particles or material powders onto a surface of a coating object, and depositing the material particles on the surface of the coating object to coat the coating object.

The cold spray method has the following features. That is, a temperature of the material particle is equal to or lower than the melting point or a softening point during the spraying, and a flow rate is as extremely high as a sonic speed to a supersonic speed. When the cold spray method is used, the porous layer 6 can be formed with high adhesion strength between the positive electrode base material 4 and the metallic particle 8 and between the metallic particles 8. Therefore, a surface area per unit volume can be increased, a large capacity can be achieved when the capacitor has the same thickness as a structure of a conventional solid electrolytic capacitor, and a low profile can be implemented when the same capacity is obtained. Additionally, in the cold spray method, because the material particles become the coating film while being maintained in a solid state, alteration is hardly generated by oxidation or heat.

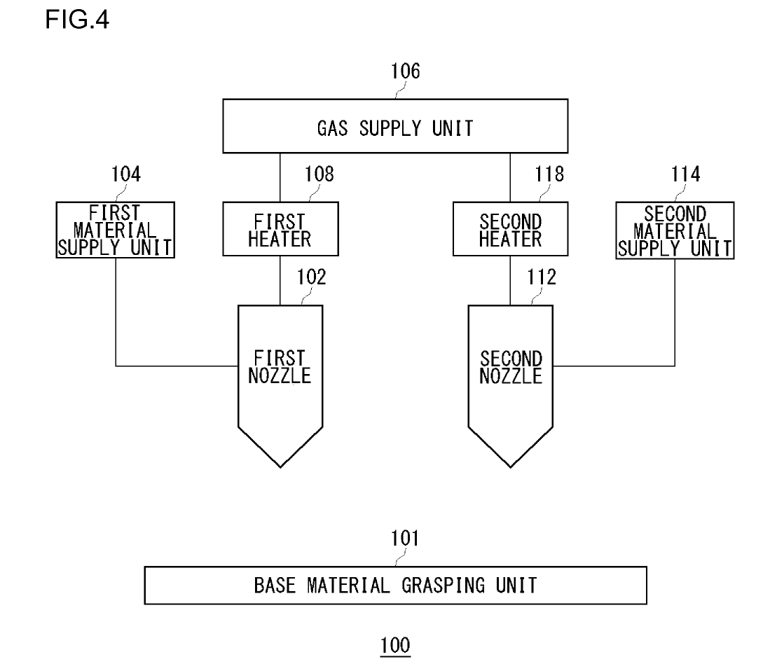

FIG. 4 is a schematic view of a cold spray apparatus. A cold spray apparatus 100 includes a base material grasping unit 101, a first nozzle 102, a first material supply unit 104, a gas supply unit 106, and a first heater 108. The cold spray apparatus 100 also includes a second nozzle 112, a second material supply unit 114, and a second heater 118. The cold spray apparatus 100 is installed in a vacuum chamber.

The base material grasping unit 101 grasps the positive electrode base material 4 which becomes the base material, and can be moved relative to the first nozzle 102 and the second nozzle 112 while the positive electrode base material 4 is heated. The first material supply unit 104 supplies the metallic particles 8 to the first nozzle 102, and the gas supply unit 106 supplies a pressurized gas to the first nozzle 102. The gas delivered from the gas supply unit 106 toward the first nozzle 102 is heated by the first heater 108 and delivered to the first nozzle 102. The metallic particles 8 supplied to the first nozzle 102 are injected from the first nozzle 102 by a pressure of the gas supplied from the gas supply unit 106.

The second material supply unit 114 supplies the organic particles 18 to the second nozzle 112, and the gas supply unit 106 supplies the pressurized gas to the second nozzle 112. The gas delivered from the gas supply unit 106 toward the second nozzle 112 is heated by the second heater 118 and delivered to the second nozzle 112. The organic particles 18 supplied to the second nozzle 112 are injected from the second nozzle 112 by the pressure of the gas supplied from the gas supply unit 106.

As illustrated in FIG. 2B, the metallic particles 8 injected at high speed from the first nozzle 102 and the organic particles 18 injected at high speed from the second nozzle 112 are sprayed onto the positive electrode base material 4 placed on the base material grasping unit 101 (see FIG. 4). The metallic particle 8 is coupled to the surface of the positive electrode base material 4 when colliding with the positive electrode base material 4, and the organic particle 18 adheres to the surface of the positive electrode base material 4 when colliding with the positive electrode base material 4.

When colliding with the metallic particle 8 coupled to the positive electrode base material 4 or the organic particle 18 adhering to the positive electrode base material 4, the injected metallic particle 8 and organic particle 18 are coupled to or adhere to the collided metallic particle 8 or organic particle 18. The metallic grain aggregate is formed by the collision between the metallic particles 8. The base material grasping unit 101 moves the positive electrode base material 4 relative to the first nozzle 102 and the second nozzle 112, thereby spraying the metallic particles 8 and the organic particles 18 onto the whole surface in a predetermined region of the positive electrode base material 4.

The injection of the metallic particle 8 from the first nozzle 102 and the injection of the organic particle 18 from the second nozzle 112 can simultaneously be performed, which allows a time necessary for a process of producing a capacitor electrode body to be shortened. Alternatively, the metallic particle 8 and the organic particle 18 may alternately be injected. Therefore, a ratio of the metallic particle 8 and the organic particle 18 can freely be adjusted according to location. The metallic particle 8 and the organic particle 18 may previously be mixed and injected from the same nozzle. The configuration of the cold spray apparatus 100 can be simplified, and therefore production cost of the capacitor 1 can be reduced. For example, the metallic particle 8 and the organic particle 18 have the diameters of 500 nm to 50 μm.

As a result, as illustrated in FIG. 2C, a composite layer 5 including the metallic particles 8 and the organic particles 18 is formed on the surface of the positive electrode base material 4. In the composite layer 5, the ratio of the metallic particle 8 and the organic particle 18 can be controlled by adjusting an amount of metallic particle 8 supplied from the first material supply unit 104 to the first nozzle 102 and/or an amount of organic particle 18 supplied from the second material supply unit 114 to the second nozzle 112.

Then, as illustrated in FIG. 2D, the organic particles 18 are removed by heating the positive electrode base material 4 in which the composite layer 5 is formed to a temperature of at least the boiling point of the organic particle 18. Therefore, a portion in which the organic particle 18 exists becomes the gap 9 to form the porous layer 6, in which the metallic particles 8 are coupled into a network structure, on the surface of the positive electrode base material 4. The positive electrode body 2 which is the capacitor electrode body is formed through the processes. For example, the porous layer 6 has the thickness of about 500 μm.

As described above, the organic particles 18 are removed after the organic particles 18 are sprayed along with the metallic particles 8, which allows the porous layer to be simply formed. At this point, avoid ratio (porosity) of the porous layer 6 can easily be controlled by adjusting the ratio of the metallic particle 8 and the organic particle 18. The void ratio of the porous layer 6 can also be controlled by adjusting particle diameters of the metallic particle 8 and the organic particle 18, an injection speed from each nozzle, and the temperature of the injection gas. For example, a smaller particle diameter of the metallic particles 8 and a lower particle injection speed allow the porous layer 6 to be formed with an increased void ratio. The temperature of the injection gas is lowered, which allows the porous layer 6 to be formed with the void ratio increased.

In the first embodiment, for example, a region including about 100 metallic particles 8 is defined in a sectional image of the porous layer 6 which is taken by a transmission electron microscope (TEM), and the void ratio can be computed from an area ratio of a portion of the metallic particle 8 including the dielectric layer 10 in the region and other portions, namely, the gap 9 (portion of the conductive polymer layer 14 after the capacitor 1 is completed).

Then, as illustrated in FIG. 3A, the surface of the positive electrode body 2 is oxidized to form the dielectric layer 10. Because the positive electrode base material 4 and the metallic particle 8 are made of Ta, the dielectric layer 10 is an oxide coating made of tantalum oxide (Ta₂O₅). In the first embodiment, the dielectric layer 10 is formed by performing the electrolytic formation treatment to the positive electrode body 2. Specifically, the anode oxidation of the positive electrode body 2 is performed at a constant voltage in an electrolytic solution of a phosphoric acid aqueous solution of 0.01 to 1.0 weight %, and the oxide coating made of oxide tantalum is formed on the surface of the positive electrode body 2, whereby the dielectric layer 10 is formed on the exposed surface of the positive electrode base material 4 and the surface of the metallic grain aggregate in which the metallic particles 8 are coupled.

As illustrated in FIG. 3B, the conductive polymer layer 14 is formed on the dielectric layer 10 by chemical oxidative polymerization such that the surface of the dielectric layer 10 is covered therewith, namely, such that the gap 9 of the positive electrode body 2 is filled therewith. Specifically, after the positive electrode body 2 is dipped in a chemical polymerization solution containing 3,4-ethylenedioxythiophene, iron (III) p-toluenesulfonate, and 1-butanol, a heat treatment is performed to the positive electrode body 2 in the atmosphere to form a polythiophene layer on the dielectric layer 10, thereby forming the conductive polymer layer 14. The process of dipping the positive electrode body 2 in the chemical polymerization solution and the heat treatment process are repeatedly performed plural times. Examples of the conductive polymer layer 14 include a layer made of the conductive polymer such as polypyrrole and polyaniline and a layer made of the TCQN complex salt in addition to the polythiophene layer.

As illustrated in FIG. 3C, the carbon paste layer 16a and the silver paste layer 16b are stacked in this order on the conductive polymer layer 14 to form the negative electrode base material 16. Therefore, the negative electrode body 12 including the conductive polymer layer 14 and the negative electrode base material 16 is formed. For example, the positive electrode terminal (not illustrated) is connected to the positive electrode base material 4 through a conductive adhesive, and the negative electrode terminal (not illustrated) is connected to the negative electrode base material 16 through a conductive adhesive.

The capacitor 1 of the first embodiment can be produced through the processes.

Accordingly, in the capacitor electrode body and capacitor producing method of the first embodiment, the metallic particles 8 and the organic particles 18 are sprayed onto the positive electrode base material 4 by the cold spray method to form the porous positive electrode body 2. Therefore, the surface area per unit volume of the positive electrode body can dramatically be increased to enable the large-capacity capacitor. The organic particles 18 are injected along with the metallic particles 8, and the organic particles 18 are removed to form the porous layer 6, so that the porous positive electrode body can simply be formed.

In the solid electrolytic capacitor having the conventional structure, there is a limitation in the producing method, in which the positive electrode body is thinned to achieve the low profile while the surface area of the positive electrode body is secured to enable the large capacity. That is, it is necessary that a powder aggregate have a certain level of thickness in order to perform the pressure forming to the valve metal. When the pressure forming is performed to the valve metal powder at a higher pressure in order to achieve the low profile of the capacitor, unfortunately the gap between the particles is clogged to reduce the surface area of the positive electrode body. On the other hand, according to the capacitor electrode body and capacitor producing method of the first embodiment, the surface area per unit volume of the positive electrode body is dramatically increased, so that the positive electrode body volume necessary to obtain the desired capacity can be reduced. As a result, the low profile of the capacitor can be implemented.

### Second Embodiment

A capacitor electrode body Producing Method and capacitor producing method according to a second embodiment of the invention differs from that of the first embodiment in that the metallic particles 8 and the organic particles 18 are injected as composite particles. The second embodiment will be described below. In the second embodiment, other configurations and other producing processes of the capacitor are basically identical to those of the first embodiment. The same component as the first embodiment is designated by the same numeral, and the description will not be repeated as appropriate.

(Capacitor Electrode Body Producing Method and Capacitor Producing Method)

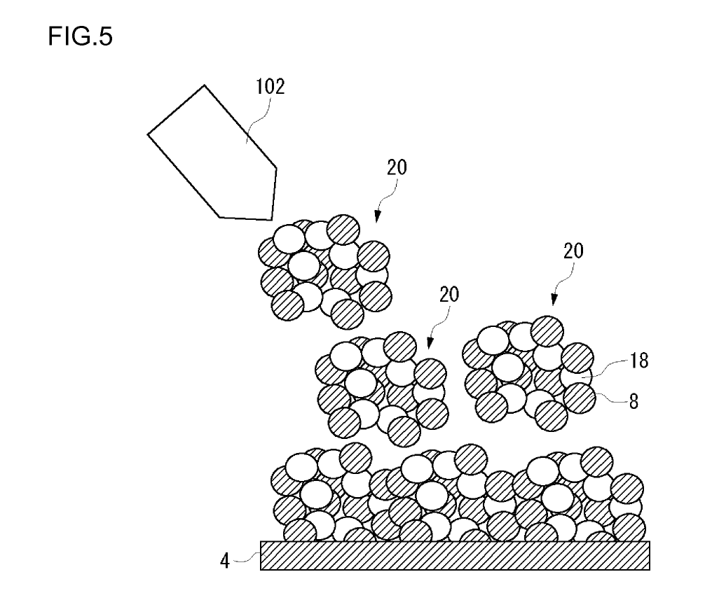

The capacitor producing method of the second embodiment will be described with reference to FIG. 5. FIG. 5 is a process sectional view illustrating the capacitor producing method of the second embodiment.

The producing method of the second embodiment differs from that of the first embodiment only in the process of spraying the metallic particle 8 and the organic particle 18 illustrated in FIG. 2B. That is, in the second embodiment, the positive electrode base material 4 is prepared similarly to the process illustrated in FIG. 2A. The metallic particle 8 and the organic particle 18 are mixed and pressurized to form a composite particle 20 which becomes apparently one particle, and the first material supply unit 104 (see FIG. 4) is filled with the composite particles 20.

As illustrated in FIG. 5, the composite particles 20 are injected from the first nozzle 102 to spray the composite particles 20 onto the surface of the positive electrode base material 4 by the cold spray method. As a result, the composite layer 5 is formed on the surface of the positive electrode base material 4 as illustrated in FIG. 2C.

Similarly to the processes illustrated in FIGS. 2D to 3C, the organic particles 18 are removed to form the porous layer 6, thereby forming the positive electrode body 2. The surface of the positive electrode body 2 is oxidized to form the dielectric layer 10, and the conductive polymer layer 14 is formed on the dielectric layer 10. Then the negative electrode base material 16 is stacked on the conductive polymer layer 14 to form the negative electrode body 12. The positive electrode terminal (not illustrated) is connected to the positive electrode base material 4, and the negative electrode terminal (not illustrated) is connected to the negative electrode base material 16, thereby completing the capacitor 1.

Therefore, according to the configuration of the second embodiment, the following effects are obtained in addition to the effects of the first embodiment. In the second embodiment, the composite particle 20 including the metallic particle 8 and the organic particle 18 is injected, so that the time necessary for the capacitor electrode body producing process can be shortened. Because only one nozzle is used in the cold spray apparatus 100, the configuration of the cold spray apparatus 100 can be simplified, and therefore the production cost of the capacitor 1 can be reduced. Compared with the case in which the metallic particle 8 and the organic particle 18 are simply mixed and injected without making the composite particle, the ratio of the metallic particle 8 and the organic particle 18 can more accurately be managed.

### Third Embodiment

A capacitor electrode body Producing Method and capacitor producing method according to a third embodiment of the invention differs from that of the first embodiment in that the organic particles 18 are used as part of the conductive polymer layer 14. The third embodiment will be described below. In the third embodiment, other configurations and other producing processes of the capacitor are basically identical to those of the first embodiment. The same component as the first embodiment is designated by the same numeral, and the description will not be repeated as appropriate.

(Capacitor Electrode Body Producing Method and Capacitor Producing Method)

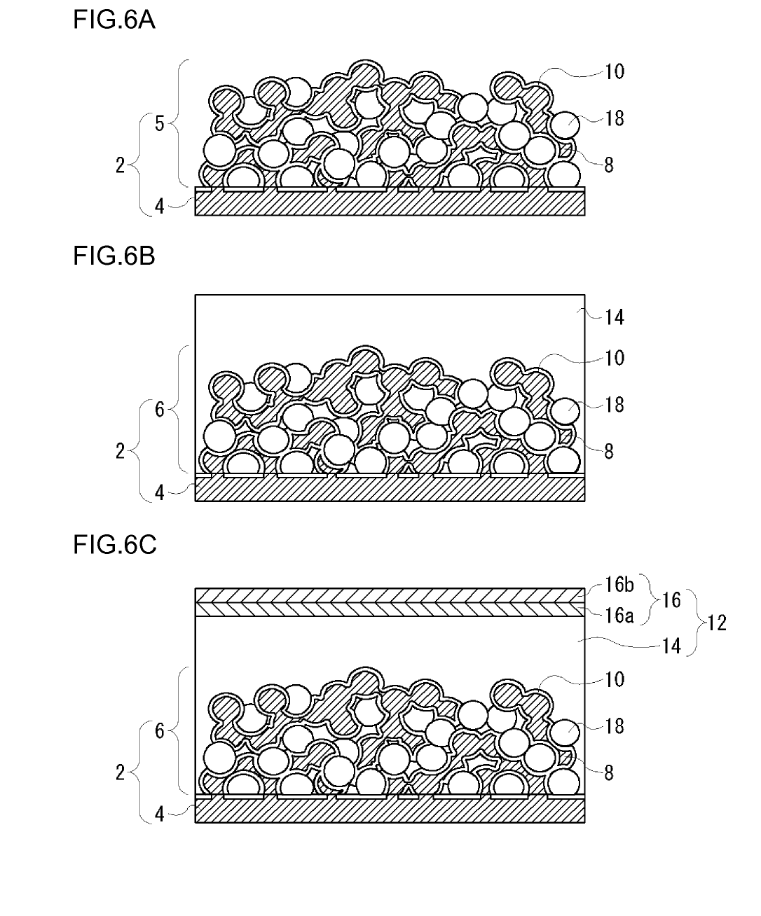

The capacitor producing method of the third embodiment will be described with reference to FIG. 6. FIGS. 6A to 6C are process sectional views illustrating the capacitor producing method of the third embodiment.

The third embodiment is identical to the first embodiment in the producing processes illustrated in FIGS. 2A to 2C. That is, in the third embodiment, the positive electrode base material 4 is prepared similarly to the process illustrated in FIG. 2A. As illustrated in FIG. 2B, the metallic particles 8 and the organic particles 18 are injected from the first nozzle 102 and the second nozzle 112 by the cold spray method, respectively. As illustrated in FIG. 2C, the composite layer 5 including the metallic particles 8 and the organic particles 18 is formed on the surface of the positive electrode base material 4.

Then, as illustrated in FIG. 6A, while the organic particles 18 are left, the surface of the positive electrode body 2 is oxidized to form the dielectric layer 10. The dielectric layer 10 is formed by an oxidation method of being able to also oxidize a portion which comes into contact with the organic particle 18 on the surfaces of the positive electrode base material 4 and metallic particle 8. The electrolytic formation treatment (anode oxidation) can be cited as an example of the oxidation method.

As illustrated in FIG. 6B, the conductive polymer layer 14 is formed on the dielectric layer 10 by the chemical oxidative polymerization such that the gap in the composite layer is filled therewith. The organic particle 18 of the third embodiment is made of a conductive polymer material such as polypyrrole and polythiophene, whereby the organic particle 18 has conductivity. Accordingly, the organic particle 18 that is in contact with the conductive polymer layer 14 acts as part of the conductive polymer layer 14. As a result, the composite layer 5 becomes the porous layer 6 having many gaps in which many metallic particles 8 are coupled into a network structure.

As illustrated in FIG. 6C, the carbon paste layer 16a and the silver paste layer 16b are stacked on the conductive polymer layer 14 to form the negative electrode base material 16, thereby forming the negative electrode body 12. The positive electrode terminal (not illustrated) is connected to the positive electrode base material 4, and the negative electrode terminal (not illustrated) is connected to the negative electrode base material 16, thereby producing the capacitor 1.

Therefore, according to the configuration of the third embodiment, the following effects are obtained in addition to the effects of the first embodiment. In the third embodiment, the organic particles 18 are not removed, but used as part of the conductive polymer layer 14. The number of processes of producing the capacitor electrode body can be decreased, and therefore the number of processes of producing the capacitor can be decreased.

### Fourth Embodiment

A capacitor electrode body Producing Method and capacitor producing method according to a fourth embodiment of the invention differs from that of the first embodiment in that the metallic particles 8 are singularly sprayed onto the positive electrode base material 4. The fourth embodiment will be described below. In the fourth embodiment, other configurations and other producing processes of the capacitor are basically identical to those of the first embodiment. The same component as the first embodiment is designated by the same numeral, and the description will not be repeated as appropriate.

(Capacitor Electrode Body Producing Method and Capacitor Producing Method)

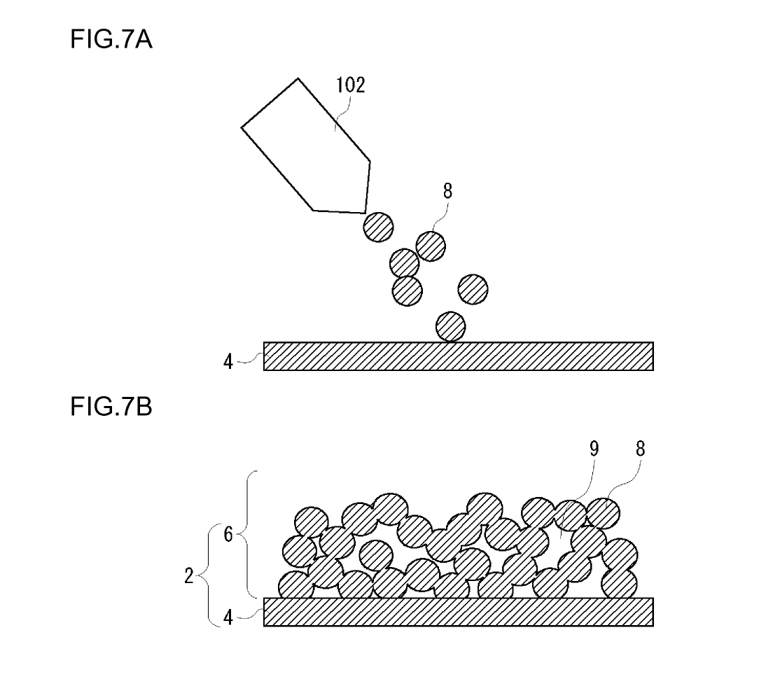

The capacitor producing method of the fourth embodiment will be described with reference to FIG. 7. FIGS. 7A and 7B are process sectional views illustrating the capacitor producing method of the fourth embodiment.

In the fourth embodiment, first the positive electrode base material 4 is prepared similarly to the process illustrated in FIG. 2A. As illustrated in FIG. 7A, the metallic particles 8 are injected from the first nozzle 102 by the cold spray method. As a result, as illustrated in FIG. 7B, the porous layer 6 in which the metallic particles 8 are coupled into a network structure is formed with the gaps 9 on the surface of the positive electrode base material 4, thereby forming the positive electrode body 2.

Similarly to the processes illustrated in FIGS. 3A to 3C, the surface of the positive electrode body 2 is oxidized to form the dielectric layer 10, and the conductive polymer layer 14 is formed on the dielectric layer 10. Then the negative electrode base material 16 is stacked on the conductive polymer layer 14 to form the negative electrode body 12. The positive electrode terminal (not illustrated) is connected to the positive electrode base material 4, and the negative electrode terminal (not illustrated) is connected to the negative electrode base material 16, thereby completing the capacitor 1.

Therefore, according to the configuration of the fourth embodiment, the organic particles 18 are not injected, but only the metallic particles 8 are injected to form the porous layer 6. The number of materials necessary to produce the positive electrode body 2 and the capacitor 1 is decreased, so that the production cost of the positive electrode body 2 and the capacitor 1 can be reduced. Because the metallic particles 8 are sprayed onto the positive electrode base material 18 by the cold spray method, the surface area per unit volume can be enlarged compared with the capacitor having the conventional structure, and a balance between the large capacity and the low profile can be achieved in the capacitor 1. Because only one nozzle is used in the cold spray apparatus 100, the configuration of the cold spray apparatus 100 can be simplified, and therefore the production cost of the capacitor 1 can be reduced.

### Fifth Embodiment

A capacitor electrode body Producing Method and capacitor producing method according to a fifth embodiment of the invention differs from that of the second or fourth embodiment in that the metallic particles 8 are sprayed as the composite particles onto the positive electrode base material 4. The fifth embodiment will be described below. In the fifth embodiment, other configurations and other producing processes of the capacitor are basically identical to those of the second or fourth embodiment. The same component as the second or fourth embodiment is designated by the same numeral, and the description will not be repeated as appropriate.

(Capacitor Electrode Body Producing Method and Capacitor Producing Method)

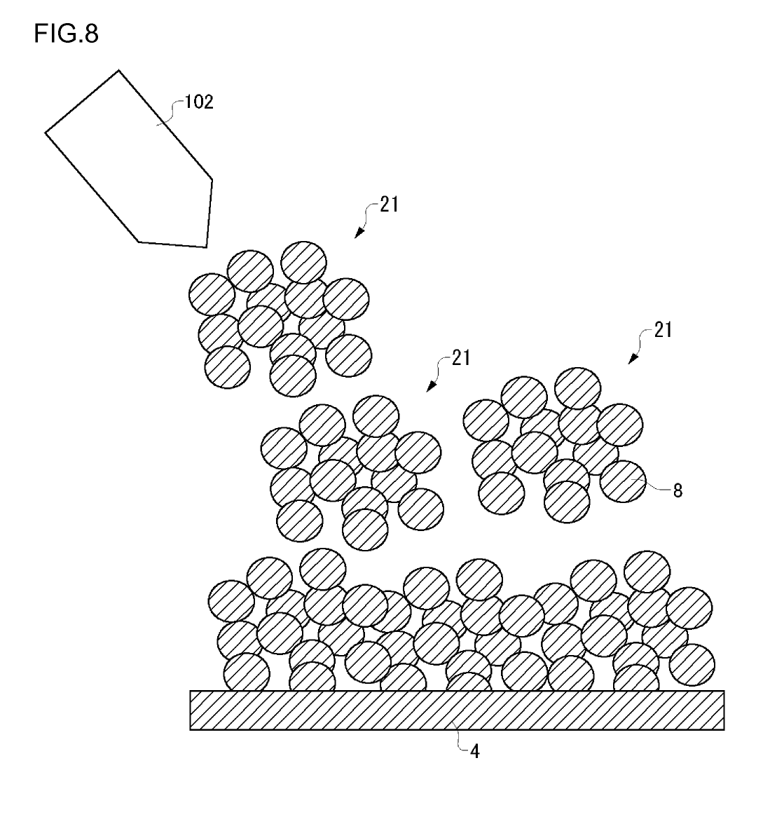

The capacitor producing method of the fifth embodiment will be described with reference to FIG. 8. FIG. 8 is a process sectional view illustrating the capacitor producing method of the fifth embodiment.

In the fifth embodiment, first the positive electrode base material 4 is prepared similarly to the process illustrated in FIG. 2A. The plural metallic particles 8 are coupled to form a composite particle 21 which becomes apparently one particle, and the first material supply unit 104 (see FIG. 4) is filled with the composite particles 21.

As illustrated in FIG. 8, the composite particles 21 are injected from the first nozzle 102 to spray the composite particles 21 onto the surface of the positive electrode base material 4 by the cold spray method. As a result, as illustrated in FIG. 7B, the porous layer 6 is formed on the surface of the positive electrode base material 4, thereby forming the positive electrode body 2.

Similarly to the processes illustrated in FIGS. 3A to 3C, the surface of the positive electrode body 2 is oxidized to form the dielectric layer 10, and the conductive polymer layer 14 is formed on the dielectric layer 10. Then the negative electrode base material 16 is stacked on the conductive polymer layer 14 to form the negative electrode body 12. The positive electrode terminal (not illustrated) is connected to the positive electrode base material 4, and the negative electrode terminal (not illustrated) is connected to the negative electrode base material 16, thereby completing the capacitor 1.

Accordingly, in the fifth embodiment, because the composite particle 21 including the plural metallic particles 8 is injected, the effect that the time necessary for the capacitor electrode body producing process can be shortened is obtained in addition to the effects of the fourth embodiment.

### Sixth Embodiment

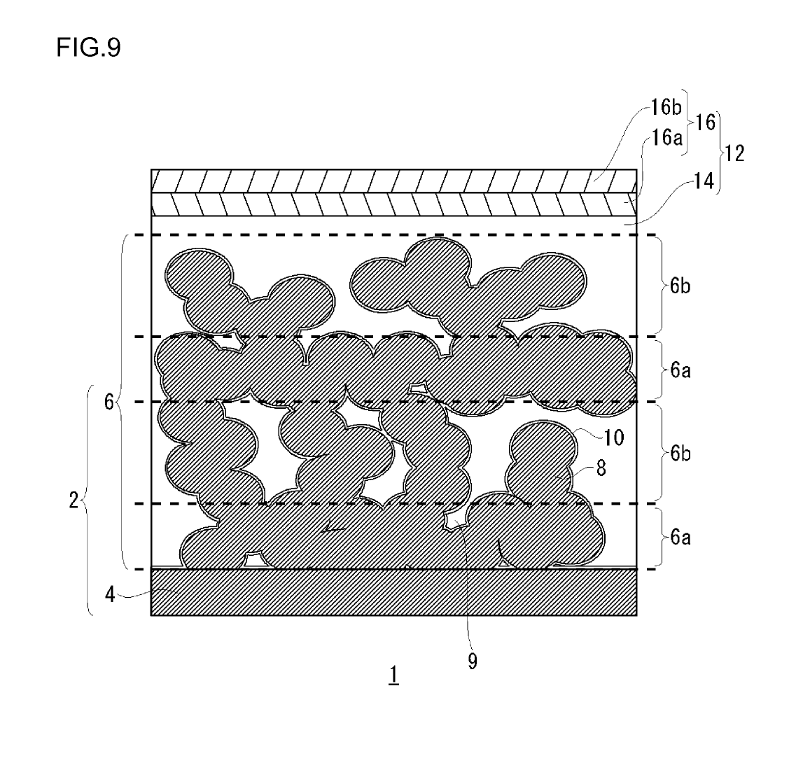

FIG. 9 is a process sectional view illustrating a configuration of a capacitor according to a sixth embodiment of the invention. A capacitor 1 of the sixth embodiment includes the positive electrode body 2, the dielectric layer 10 which is formed on the surface of the positive electrode body 2, and the negative electrode body 12 which is formed across the dielectric layer 10 from the positive electrode body 2.

The positive electrode body 2 includes the positive electrode base material 4 (corresponding to the base material of the invention) which is made of a conductive material and the porous layer 6 which is provided on the positive electrode base material 4. The porous layer 6 includes the metallic grain aggregate in which the plural metallic particles 8 made of at least one of the valve metal and the alloy thereof are coupled. There is no particular limitation to the positive electrode base material 4 as long as the positive electrode base material 4 is made of the conductive material. For example, at least one of the valve metal and the alloy thereof is suitably used. The positive electrode base material 4 includes the thin film (foil), the lead wire, and the film-shaped structure in which plural metallic particles 8 are coupled. The extraction positive electrode terminal (not illustrated) is connected to the positive electrode base material 4.

In the sixth embodiment, Ta is used as the metals for the positive electrode base material 4 and the metallic particle 8. Alternatively, the positive electrode base material 4 and the metallic particle 8 may be made of different metals.

The porous layer 6 includes a dense layer 6a and a scattered layer 6b. In the dense layer 6a, the number of metallic particles 8 per unit volume is relatively increased, and therefore the void ratio is relatively low. In the scattered layer 6b, the number of metallic particles 8 per unit volume is relatively decreased, and therefore the void ratio is relatively high. The porous layer 6 includes the plural gaps 9 as a whole and has a structure in which the many coupled metallic particles 8 form the network. It is only necessary that at least each one of the dense layer 6a and the scattered layer 6b be stacked on the same surface side of the positive electrode base material 4. In the sixth embodiment, the plural dense layers 6a and scattered layers 6b, specifically each two of the dense layers 6a and the scattered layers 6b, are alternately stacked on the positive electrode base material 4. There is no particular limitation to a layer which is provided immediately above the positive electrode base material 4, namely, a layer which is in contact with the surface of the positive electrode base material 4. In the sixth embodiment, the dense layer 6a is provided immediately above the positive electrode base material 4.

For example, the positive electrode base material 4 has the thickness of about 100 μm when the positive electrode base material 4 is a metallic foil. For example, the porous layer 6 has the thickness of about 200 nm to about 5 mm, and the dense layer 6a and the scattered layer 6b have the thickness of about 100 nm to about 500 μm, respectively. For example, the metallic particle 8 has the diameter of about 100 nm to about 50 μm. Preferably the thickness in the stacking direction of the dense layer 6a is lower than the thickness in the stacking direction of the scattered layer 6b, thereby contributing to the large capacity and low ESR of the capacitor 1. Preferably the void ratio of the scattered layer 6b ranges from 30 to 80%, and preferably the void ratio of the dense layer 6a is lower than that of the scattered layer 6b and is less than 50%.

In the sixth embodiment, for example, the region including about 100 metallic particles 8 is defined in the sectional image of the porous layer 6 which is taken by the transmission electron microscope (TEM), and the void ratio can be computed from an area ratio of a metallic grain aggregate portion including the dielectric layer 10 in the region and other portions, namely, the gap 9 (portion of the conductive polymer layer 14 after the capacitor 1 is completed).

When the positive electrode base material 4 is made of a conductive material such as nickel (Ni) which is not the valve metal, preferably the dense layer 6a is stacked immediately above the positive electrode base material 4. At this point, desirably the dense layer 6a has the void ratio of several percent, namely, is less than 10%. Therefore, because the substantially whole surface of the positive electrode base material 4 is covered with the metallic grain aggregate including the metallic particles 8 which are made of at least one of the valve metal and the alloy thereof, an increase in leakage current can securely be avoided when the conductive material which is neither the valve metal nor the alloy thereof is used as the material for the positive electrode base material 4.

The dielectric layer 10 is the oxide coating which is formed on the surface of the positive electrode body 2 by, for example, the electrolytic formation treatment. The dielectric layer 10 is formed on the surface where the positive electrode base material 4 and the porous layer 6 are exposed, namely, a region except a region where the metallic particles 8 or the metallic particle 8 and the positive electrode base material 4 come into contact with each other.

The negative electrode body 12 includes the conductive polymer layer 14 and the negative electrode base material 16 which is stacked on the conductive polymer layer 14. The conductive polymer layer 14 acts as the electrolytic layer. There is not particular limitation to the conductive polymer layer 14 as long as the conductive polymer layer 14 contains a polymer material having conductivity. For example, conductive polymers such as polythiophene, polypyrrole, and polyaniline and materials such as the TCNQ (7,7,8,8-tetracyanoquinodimethane) complex salt are suitably used as the conductive polymer layer 14. The negative electrode base material 16 includes the carbon paste layer 16a which is stacked on the conductive polymer layer 14 and the silver paste layer 16b which is stacked on the carbon paste layer 16a. The extraction negative electrode terminal (not illustrated) is connected to the silver paste layer 16b.

(Capacitor Electrode Body Producing Method and Capacitor Producing Method)

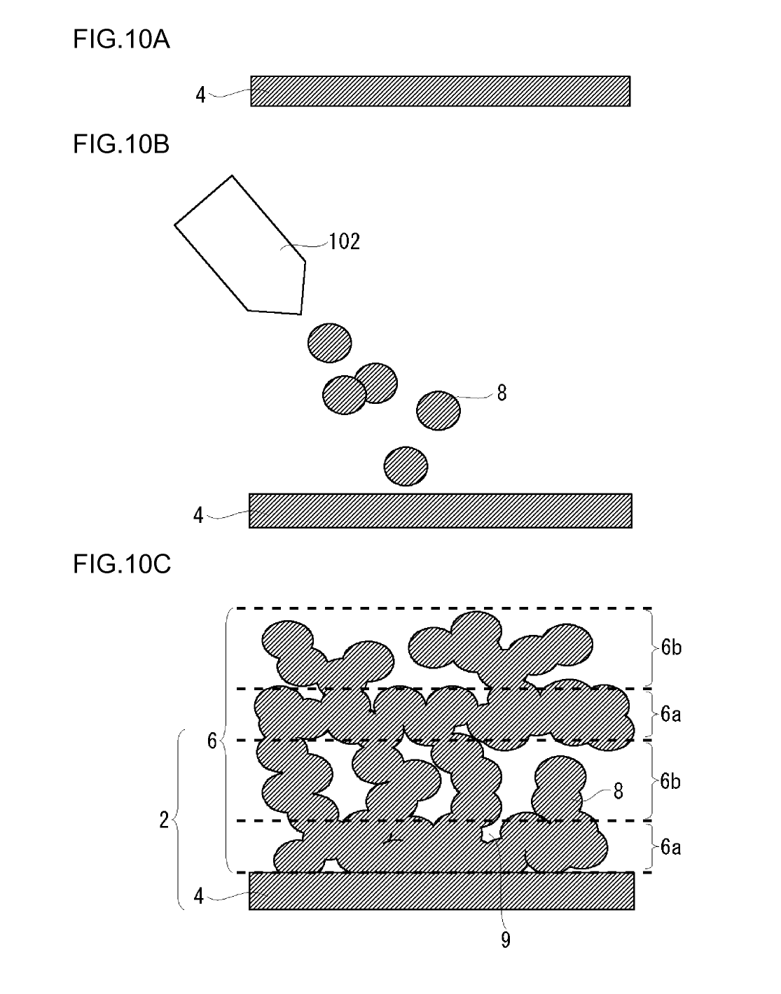

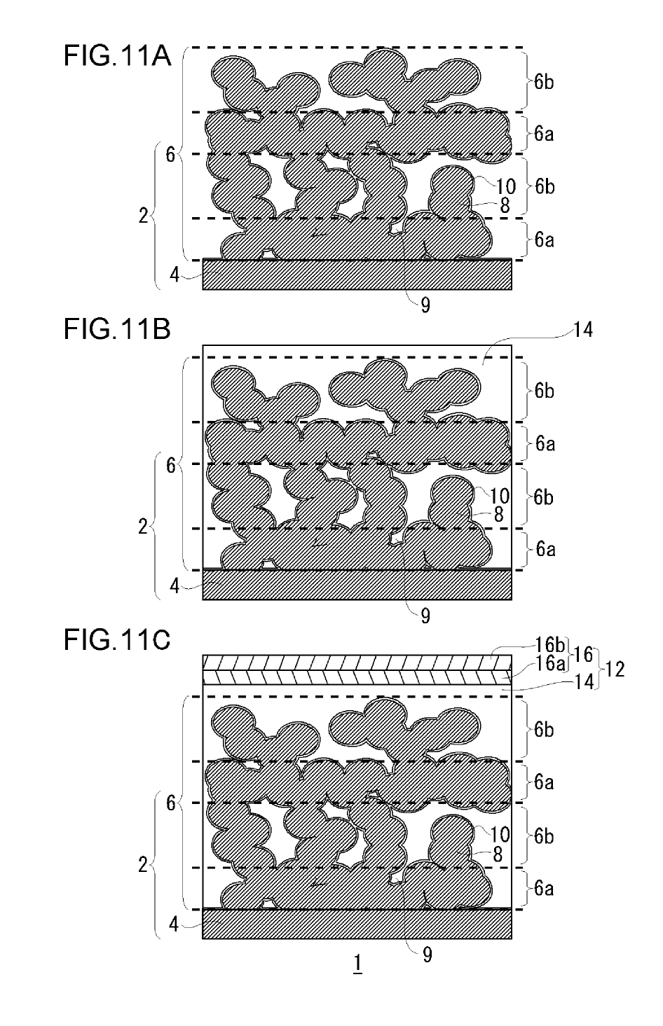

Then the method of producing the capacitor 1 of the sixth embodiment will be described with reference to FIGS. 10A to 10C and 11A to 11C. FIGS. 10A to 11C are process sectional views illustrating the capacitor producing method of the sixth embodiment.

First the positive electrode base material 4 made of the tantalum foil which is the valve metal is prepared as illustrated in FIG. 10A.

Then, as illustrated in FIG. 10B, the metallic particles 8 made of Ta are sprayed onto the surface of the positive electrode base material 4. In the sixth embodiment, the metallic particles 8 are sprayed onto the positive electrode base material 4 by the cold spray method.

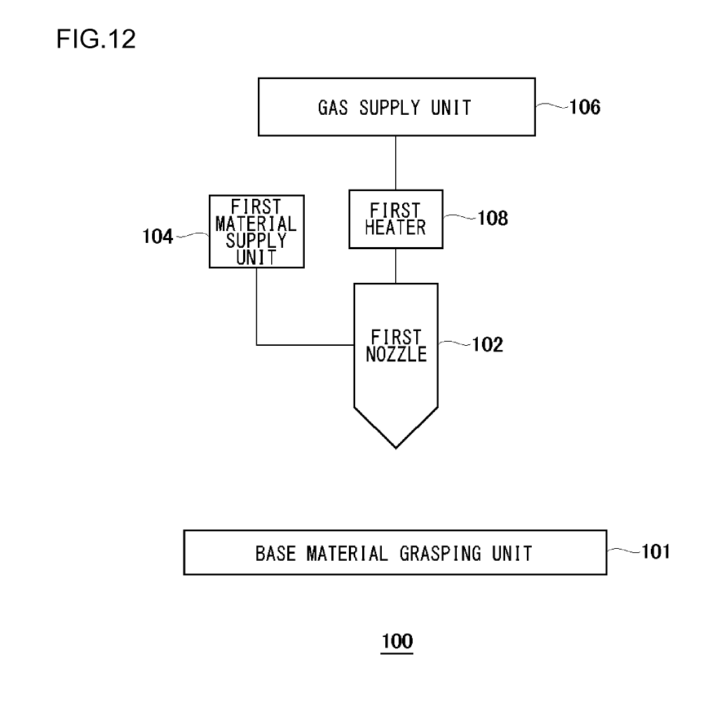

FIG. 12 is a schematic view of a cold spray apparatus. A cold spray apparatus 100 includes the base material grasping unit 101, the first nozzle 102, the first material supply unit 104, the gas supply unit 106, and the first heater 108.

The base material grasping unit 101 grasps the positive electrode base material 4, and can be moved relative to the first nozzle 102 and while the positive electrode base material 4 is heated. The first material supply unit 104 supplies the metallic particles 8 to the first nozzle 102, and the gas supply unit 106 supplies a pressurized gas to the first nozzle 102. The gas delivered from the gas supply unit 106 toward the first nozzle 102 is heated by the first heater 108 and delivered to the first nozzle 102. The metallic particles 8 supplied to the first nozzle 102 are injected from the first nozzle 102 by a pressure of the gas supplied from the gas supply unit 106. Alternatively, the first nozzle 102 may be moved relative to the base material grasping unit 101.

As illustrated in FIG. 10B, the metallic particles 8 injected from the first nozzle 102 are sprayed onto the positive electrode base material 4 placed on the base material grasping unit 101 (see FIG. 12). The metallic particle 8 is coupled to the surface of the positive electrode base material 4 when colliding with the positive electrode base material 4. When colliding with the metallic particle 8 coupled to the positive electrode base material 4, the injected metallic particle 8 is coupled to the collided metallic particle 8. Therefore, the metallic grain aggregate is formed by coupling the metallic particles 8. The base material grasping unit 101 moves the positive electrode base material 4 relative to the first nozzle 102, thereby spraying the metallic particles 8 onto the whole surface in a predetermined region of the positive electrode base material 4.

The number of metallic particles 8 per unit volume, namely, the void ratio of the formed layer can be controlled by changing the speed of the metallic particle 8 injected from the first nozzle 102. The dense layer 6a having the low void ratio can be formed by increasing the injection speed of the metallic particle 8, and the scattered layer 6b having the high void ratio can be formed by decreasing the injection speed of the metallic particle 8. As a result, as illustrated in FIG. 10C, the porous layer 6 in which the dense layers 6a and the scattered layers 6b are stacked is formed on the surface of the positive electrode base material 4. The porous layer 6 includes the gaps 9 and has the structure in which the metallic particles 8 are coupled into a network structure. The positive electrode body 2 which is the capacitor electrode body is formed through the processes. For example, the porous layer 6 has the thickness of about 500 μm. The void ratio can be controlled by changing a temperature of the gas injected from the first nozzle 102. The dense layer 6a having the low void ratio can be formed by increasing the injection gas temperature, and the scattered layer 6b having the high void ratio can be formed by decreasing the injection gas temperature. The formation of the dense layer 6a and the scattered layer 6b can also be controlled by adjusting the amount of metallic particle 8 supplied from the first material supply unit 104 to the first nozzle 102.

Then, as illustrated in FIG. 11A, the surface of the positive electrode body 2 is oxidized to form the dielectric layer 10. Because the positive electrode base material 4 and the metallic particle 8 are made of Ta, the dielectric layer 10 is the oxide coating made of tantalum oxide (Ta₂O₅). In the sixth embodiment, the dielectric layer 10 is formed by performing the electrolytic formation treatment to the positive electrode body 2. Specifically, the anode oxidation of the positive electrode body 2 is performed at a constant voltage in the electrolytic solution of the phosphoric acid aqueous solution of 0.01 to 1.0 weight %, and the oxide coating made of oxide tantalum is formed on the surface of the positive electrode body 2, whereby the dielectric layer 10 is formed on the exposed surface of the positive electrode base material 4 and the surface of the metallic grain aggregate.

As illustrated in FIG. 11B, the conductive polymer layer 14 is formed on the dielectric layer 10 by the chemical oxidative polymerization such that the surface of the dielectric layer 10 is covered therewith, namely, such that the gap 9 in the porous portion of the positive electrode body 2 is filled therewith. Specifically, after the positive electrode body 2 is dipped in the chemical polymerization solution containing 3,4-ethylenedioxythiophene, iron (III) p-toluenesulfonate, and 1-butanol, the heat treatment is performed to the positive electrode body 2 in the atmosphere to form the polythiophene layer on the dielectric layer 10, thereby forming the conductive polymer layer 14. The process of dipping the positive electrode body 2 in the chemical polymerization solution and the heat treatment process are repeatedly performed plural times. Examples of the conductive polymer layer 14 include the layer made of the conductive polymer such as polypyrrole and polyaniline and the layer made of the TCQN complex salt in addition to the polythiophene layer.

As illustrated in FIG. 11C, the carbon paste layer 16a and the silver paste layer 16b are stacked in this order on the conductive polymer layer 14 to form the negative electrode base material 16. Therefore, the negative electrode body 12 including the conductive polymer layer 14 and the negative electrode base material 16 is formed. For example, the positive electrode terminal (not illustrated) is connected to the positive electrode base material 4 through the conductive adhesive, and the negative electrode terminal (not illustrated) is connected to the negative electrode base material 16 through the conductive adhesive.

The capacitor 1 of the sixth embodiment can be produced through the processes.

Accordingly, the positive electrode body 2 which is the capacitor electrode body and capacitor 1 of the sixth embodiment have the structure in which the dense layers 6a having the relatively low void ratio and the scattered layers 6b having the relatively high void ratio are stacked on the positive electrode base material 4. Conventionally, with miniaturization and an increase in operating frequency of electronic devices typified by a personal computer and a mobile phone, there is an increasing demand for miniaturization, large capacity, and low ESR (Equivalent Series Resistance) in capacitors mounted on the electronic devices. A solid electrolytic capacitor in which a conductive polymer is used as a solid electrolyte has been developed as the capacitor that can meet the demand. However, recently the low ESR is further demanded in the capacitors mounted on the electronic devices with the further miniaturization and increase in operating frequency of the electronic devices. Generally an outer package of the capacitor is formed by resin molding while the dielectric layer 10 and the negative electrode body 12 are stacked on the positive electrode body 2, and a stress generated by a forming pressure or forming heat during the resin molding of the outer package is applied to the porous layer 6 or the conductive polymer layer 14 to possibly generate a crack or a peel-off in the porous layer 6 or the conductive polymer layer 14. On the other hand, in the configuration of the capacitor 1 of the sixth embodiment, because the dense layer 6a having rigidity higher than that of the scattered layer 6b is interposed between the positive electrode base material 4 and the negative electrode base material 16, the durability against the stress is improved. Therefore, damages such as the crack and the peel-off which are caused by the resin molding are hardly generated in the porous layer 6 and the conductive polymer layer 14, so that a contact area between the dielectric layer 10 and the conductive polymer layer 14 can be maintained as expected to suppress the increase in ESR caused by the damage.

The capacitor 1 has the structure in which the dense layer 6a having the relatively small resistance is disposed between the positive electrode base material 4 and the negative electrode base material 16. When the plural dense layers 6a are stacked, the capacitor 1 has the structure in which the dense layers 6a having the low resistances are arrayed in parallel between the positive electrode base material 4 and the negative electrode base material 16. The scattered layers 6b having the relatively large resistances become thinner compared with the case in which the dense layer 6a does not exist, and the scattered layers 6b are arrayed in parallel. Therefore, the further low ESR of the capacitor can be achieved.

The porous positive electrode body 2 is formed by spraying the metallic particles 8 onto the positive electrode base material 4 by the cold spray method. Therefore, the surface area per unit volume of the positive electrode body can dramatically be increased to enable the large-capacity capacitor. The volume of the positive electrode body necessary to obtain the desired capacity is reduced by the increased surface area per unit volume, so that the low-profile capacitor can be implemented. The structure in which the dense layers 6a and the scattered layers 6b are alternately stacked can more simply be formed by the use of the cold spray method.

Similarly to the fifth embodiment, the porous layer 6 (the dense layers 6a and the scattered layers 6b in which the void ratios are controlled by the method of changing the injection speed of the composite particle 21 or the like) may be formed by spraying the metallic particles 8 as the composite particles 21 onto the positive electrode base material 4. In such cases, advantageously the time necessary for the capacitor electrode body producing process can be shortened.

### Seventh Embodiment

A capacitor electrode body and capacitor according to a seventh embodiment of the invention differ from those of the sixth embodiment in that the metallic particles 8 and the organic particles 18 are injected onto the positive electrode base material 4 in the producing process. The seventh embodiment will be described below. In the seventh embodiment, other configurations and other producing processes of the capacitor are basically identical to those of the sixth embodiment. The same component as the sixth embodiment is designated by the same numeral, and the description will not be repeated as appropriate.

(Capacitor Electrode Body Producing Method and Capacitor Producing Method)

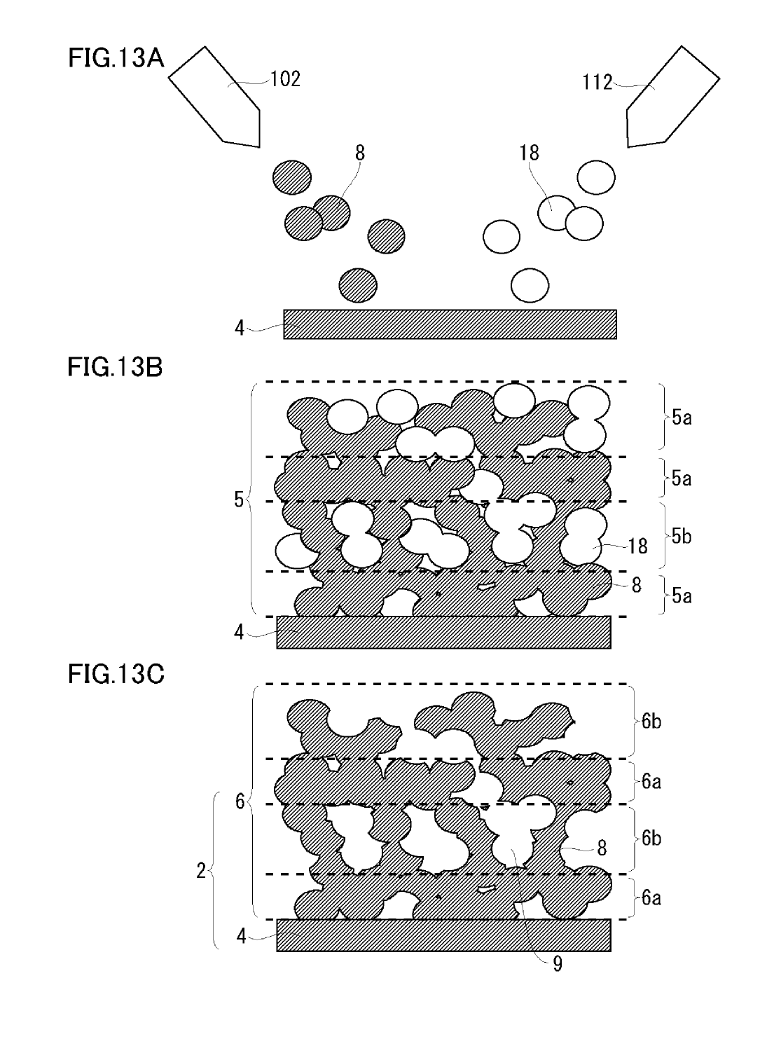

The capacitor producing method of the seventh embodiment will be described with reference to FIGS. 13A to 13C. FIGS. 13A to 13C are process sectional views illustrating the capacitor producing method of the seventh embodiment.

In the seventh embodiment, first the positive electrode base material 4 is prepared similarly to the process illustrated in FIG. 10A. As illustrated in FIG. 13A, the metallic particles 8 and the organic particles 18 are sprayed onto the surface of the positive electrode base material 4 by the cold spray method. The organic particle 18 is an organic material having the melting point of room temperature or more. Examples of the organic particle 18 include conductive polymers such as polypyrrole and polythiophene and organic semiconductors such as a TCNQ complex salt. Preferably an organic material has the boiling point of at least a temperature raised by the collision energy using the cold spray method.

The cold spray apparatus used in the seventh embodiment is identical to the cold spray apparatus illustrated in FIG. 4.

As illustrated in FIG. 13B, the metallic particles 8 injected from the first nozzle 102 and the organic particles 18 injected from the second nozzle 112 are sprayed onto the positive electrode base material 4 placed on the base material grasping unit 101 (see FIG. 4). The metallic particle 8 is coupled to the surface of the positive electrode base material 4 when colliding with the positive electrode base material 4, and the organic particle 18 adheres to the surface of the positive electrode base material 4 when colliding with the positive electrode base material 4. When colliding with the metallic particle 8 coupled to the positive electrode base material 4 or the organic particle 18 adhering to the positive electrode base material 4, the injected metallic particle 8 and organic particle 18 are coupled to or adhere to the collided metallic particle 8 or organic particle 18. The base material grasping unit 101 moves the positive electrode base material 4 relative to the first nozzle 102 and the second nozzle 112, thereby spraying the metallic particles 8 and the organic particles 18 onto the whole surface in a predetermined region of the positive electrode base material 4. For example, the metallic particle 8 and the organic particle 18 have the diameters of 500 nm to 50 μm.

As a result, as illustrated in FIG. 13B, the composite layer 5 is formed on the surface of the positive electrode base material 4. The composite layer 5 includes the metallic grain aggregate in which the metallic particles 8 are coupled to one another and the organic particles 18. The number of metallic particles 8 per unit volume in the formed layer can be controlled by changing a ratio of the amount of metallic particle 8 injected from the first nozzle 102 and the amount of organic particle 18 injected from the second nozzle 112. Therefore, as illustrated in FIG. 13B, the composite layer 5 becomes the structure in which a composite dense layer 5a having the large number of the metallic particles 8 per unit volume and the composite scattered layer 5b having the small number of the metallic particles 8 per unit volume are stacked. The formation of the composite dense layer 5a and composite scattered layer 5b can also be controlled by adjusting the amount of metallic particle 8 supplied from the first material supply unit 104 to the first nozzle 102 and the amount of organic particle 18 supplied from the second material supply unit 114 to the second nozzle 112.

Then, as illustrated in FIG. 13C, the organic particles 18 are removed by heating the positive electrode base material 4 in which the composite layer 5 is formed to the temperature of at least the boiling point of the organic particle 18. Therefore, the portion in which the organic particle 18 exists becomes the gap 9 to form the porous layer 6, in which the metallic particles 8 are coupled into a network structure, on the surface of the positive electrode base material 4. The composite dense layer 5a and the composite scattered layer 5b become the dense layer 6a and the scattered layer 6b by removing the organic particles 18, respectively. The positive electrode body 2 which is the capacitor electrode body is formed through the processes.

Similarly to the processes illustrated in FIGS. 11A to 11C, the surface of the positive electrode body 2 is oxidized to form the dielectric layer 10, and the conductive polymer layer 14 is formed on the dielectric layer 10. Then the negative electrode base material 16 is stacked on the conductive polymer layer 14 to form the negative electrode body 12. The positive electrode terminal (not illustrated) is connected to the positive electrode base material 4, and the negative electrode terminal (not illustrated) is connected to the negative electrode base material 16, thereby completing the capacitor 1.

Therefore, according to the configuration of the seventh embodiment, the following effects are obtained in addition to the effects of the sixth embodiment. In the seventh embodiment, the organic particles 18 and the metallic particles 8 are injected onto the positive electrode base material 4, and the organic particles 18 are removed to form the porous layer 6, so that the porous positive electrode body can more simply be formed. The dense layer 6a is formed while the ratio of the organic particle 18 to the metallic particle 8 is decreased compared with the case in which the scattered layer 6b is formed, and the scattered layer 6b is formed while the ratio is increased compared with the case in which the dense layer 6a is formed, so that the dense layer 6a and the scattered layer 6b can more simply be formed.

### Eighth Embodiment

A capacitor electrode body and capacitor according to an eighth embodiment of the invention differs from those of the sixth embodiment in that the capacitor electrode body and capacitor further include a connection unit with which the metallic particles 8 and/or the dense layer 6a and the positive electrode base material 4 are in contact, and the connection unit has electric resistivity smaller than that of the scattered layer 6b. The eighth embodiment will be described below. In the eighth embodiment, other configurations and other producing processes of the capacitor are basically identical to those of the sixth embodiment. The same component as the sixth embodiment is designated by the same numeral, and the description will not be repeated as appropriate.

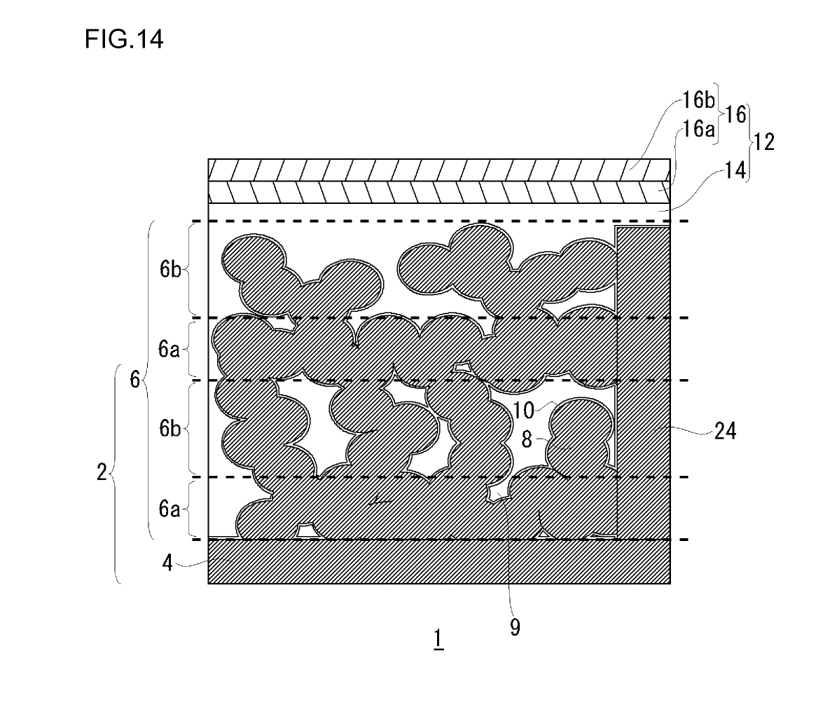

FIG. 14 is a process sectional view illustrating a configuration of the capacitor of the eighth embodiment. The capacitor 1 of the eighth embodiment includes the positive electrode body 2, the dielectric layer 10, and the negative electrode body 12. The positive electrode body 2 includes the positive electrode base material 4 and the porous layer 6. The porous layer 6 has the structure in which the dense layers 6a and the scattered layers 6b are stacked. The dense layer 6a includes the metallic grain aggregate in which the plural metallic particles 8 are coupled. The positive electrode base material 4 includes an extended unit 24 which is extended in a direction in which the dense layers 6a and the scattered layers 6b are stacked. The extended unit 24 is in contact with the dense layers 6a. In the eighth embodiment, the extended unit 24 acts as the connection unit. There is no particular limitation to the extended unit 24 as long as the extended unit 24 is made of the conductive material. For example, at least one of the valve metal and the alloy thereof is suitably used. In the eighth embodiment, Ta is used as the metals for the extended unit 24. The negative electrode body 12 includes the conductive polymer layer 14 and the negative electrode base material 16, and the negative electrode base material 16 includes the carbon paste layer 16a and a silver paste layer 16b.

The extended unit 24 can be formed by bending part of the positive electrode base material 4 when the positive electrode base material 4 is made of a metallic foil. A resist is stacked at a predetermined position on the surface of the metallic substrate, etching is performed with the resist as a mask, and the portion left because of the resist may be used as the extended unit 24 while other portions are used as the positive electrode base material 4.

The extended unit 24 is extended in the direction in which the dense layers 6a and the scattered layers 6b are stacked and is in direct contact with each dense layer 6a. Therefore, the positive electrode base material 4 and the dense layer 6a or the dense layers 6a are connected in the resistance state lower than that of the connection through the scattered layer 6b. The extended unit 24 is configured so as not to be electrically connected to the negative electrode base material 16.

Therefore, according to the configuration of the eighth embodiment, the following effect is obtained in addition to the effects of the sixth embodiment. In the eighth embodiment, the positive electrode base material 4 and the dense layer 6a are connected lower than the connection through the scattered layer 6b by the extended unit 24. Therefore, the dense layers 6a having the resistance lower than that of the scattered layers 6b are connected in parallel, so that the further low ESR of the capacitor can be achieved.

### Ninth Embodiment

A capacitor electrode body and capacitor according to a ninth embodiment of the invention differs from those of the sixth embodiment in the following point. That is, a dense unit 26 having a low void ratio is provided as the connection unit in a predetermined region of the scattered layer 6b, whereby the positive electrode base material 4 and the dense layer 6a or the dense layers 6a are connected in the resistance state lower than that of the connection through the scattered layer 6b. The ninth embodiment will be described below. In the ninth embodiment, other configurations and other producing processes of the capacitor are basically identical to those of the sixth embodiment. The same component as the sixth embodiment is designated by the same numeral, and the description will not be repeated as appropriate.

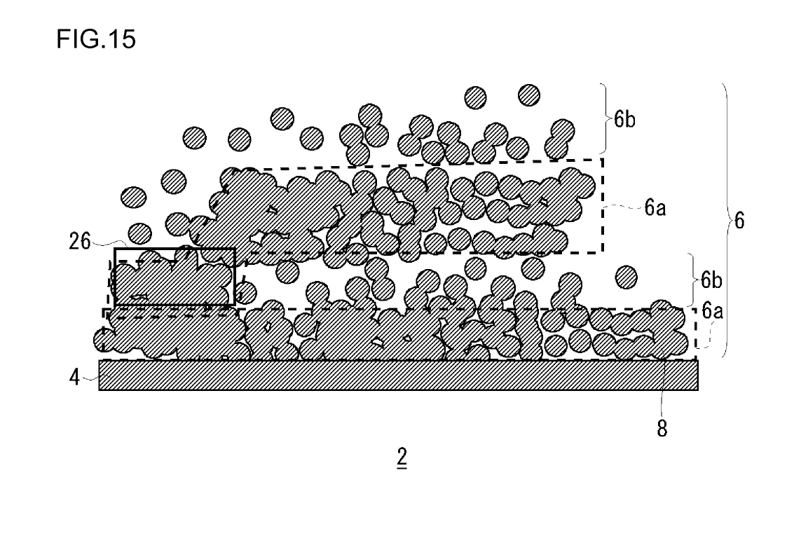

FIG. 15 is a schematic sectional view illustrating a configuration of the positive electrode body of the ninth embodiment. The positive electrode body 2 used in the capacitor of the ninth embodiment includes the positive electrode base material 4 and the porous layer 6 that is made of the plural metallic particles 8. The porous layer 6 has the structure in which the dense layers 6a and the scattered layers 6b are stacked.

In the porous layer 6, a dense unit 26 having a void ratio lower than that of other regions in the scattered layer 6b is provided in a lateral of the scattered layer 6b. In the ninth embodiment, the dense unit 26 acts as the connection unit. The dense unit 26 is extended in the direction in which the dense layers 6a and the scattered layers 6b are stacked, and is in contact with the dense layer 6a which is provided on one (lower surface in FIG. 15) of surfaces of the scattered layer 6b while being in contact with the dense layer 6a which is provided on the other surface (upper surface in FIG. 15). When the scattered layer 6b is provided immediately above the positive electrode base material 4, one end of the dense unit 26 comes into contact with the positive electrode base material 4. That is, the dense layers 6a which are provided across the scattered layer 6b from each other or the positive electrode base material 4 and the dense layer 6a are coupled through the dense unit 26. Accordingly, the dense layers 6a are coupled through the dense unit 26, and the coupled plural dense layers 6a are coupled to the positive electrode base material 4 through the dense unit 26.

The positive electrode body 2 illustrated in FIG. 15 can be formed as follows. When the metallic particles 8 are sprayed onto the positive electrode base material 4 to form the dense layer 6a using the cold spray apparatus 100, the deposition is performed while the nozzle is moved to the outside of the region where the scattered layer 6b is formed. Therefore, the region where the dense layer 6a is formed is spread to the lateral of the region where the scattered layer 6b is formed, and the portion of the dense layer 6a formed in the same layer as the scattered layer 6b constitutes the dense unit 26.

There is another method of forming the dense unit 26. That is, when the dense layer 6a is formed, the metallic particles 8 are injected while the nozzle is taken further away from the positive electrode base material 4 (or the dense layer 6a or the scattered layer 6b on the outermost surface) compared with the case in which the scattered layer 6b is formed. When the scattered layer 6b is formed, the metallic particles 8 are injected while the nozzle is brought closer to the positive electrode base material 4 compared with the case in which the dense layer 6a is formed. At this point, the injected metallic particles 8 are spread in a relatively narrow range of the positive electrode base material 4 when the nozzle is brought close to the positive electrode base material 4, and the injected metallic particles 8 are spread in a wide range of the positive electrode base material 4 when the nozzle is taken away from the positive electrode base material 4.

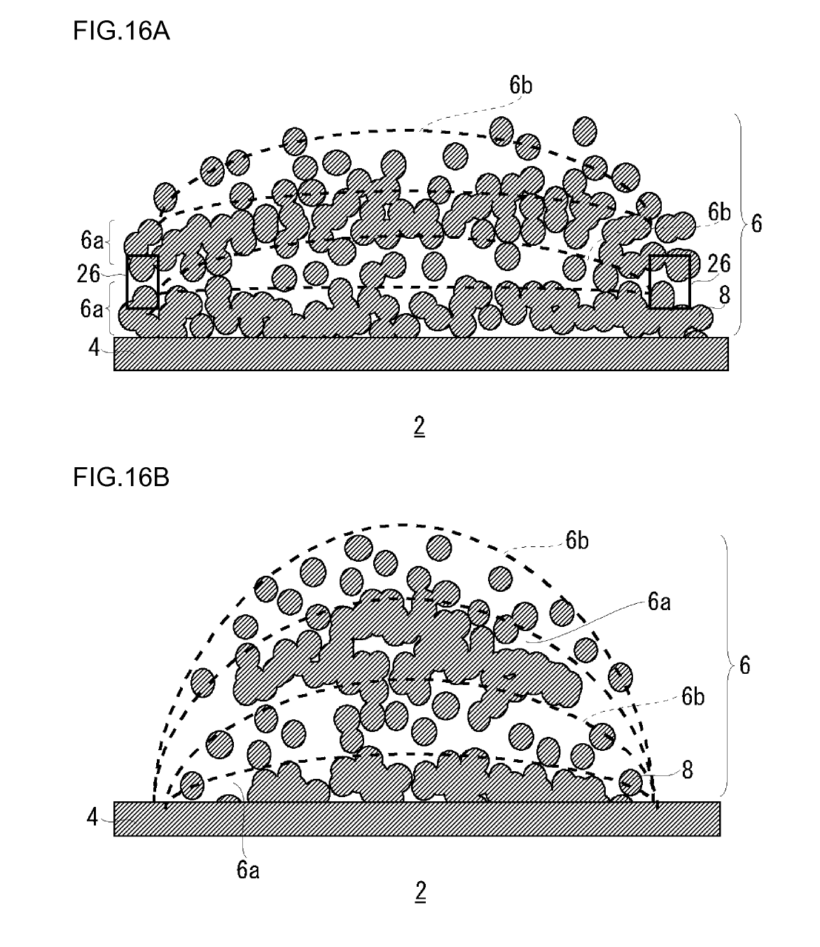

Therefore, as illustrated in FIG. 16A, by adjusting a distance between the nozzle and the positive electrode base material 4, the scattered layer 6b is formed in the center region of the positive electrode base material 4, and the dense layer 6a is formed in the region including the lateral of the scattered layer 6b. As a result, in the dense layer 6a, the portion formed in the lateral of the scattered layer 6b constitutes the dense unit 26. When the nozzle is brought close to the positive electrode base material 4 in forming the dense layer 6a while the nozzle is taken away from the positive electrode base material 4 in forming the scattered layer 6b, the scattered layer 6b is formed in the lateral of the dense layer 6a as illustrated in FIG. 16B. FIGS. 16A and 16B are schematic sectional views illustrating a configuration of a positive electrode body according to a modification of the ninth embodiment.

Therefore, according to the configuration of the ninth embodiment, the following effect is obtained in addition to the effects of the sixth embodiment. In the ninth embodiment, the dense layers 6a and/or the positive electrode base material 4 and the dense layer 6a are connected in the resistance state lower than that of the connection through the scattered layer 6b by the dense unit 26. Therefore, the further low ESR of the capacitor can be achieved.

### Tenth Embodiment

A capacitor electrode body and capacitor according to a tenth embodiment of the invention differs from those of the sixth embodiment in that the plural metallic particles 8 having different diameters are injected to form the dense layer 6a and the scattered layer 6b. The tenth embodiment will be described below. In the tenth embodiment, other configurations and other producing processes of the capacitor are basically identical to those of the sixth embodiment. The same component as the sixth embodiment is designated by the same numeral, and the description will not be repeated as appropriate.

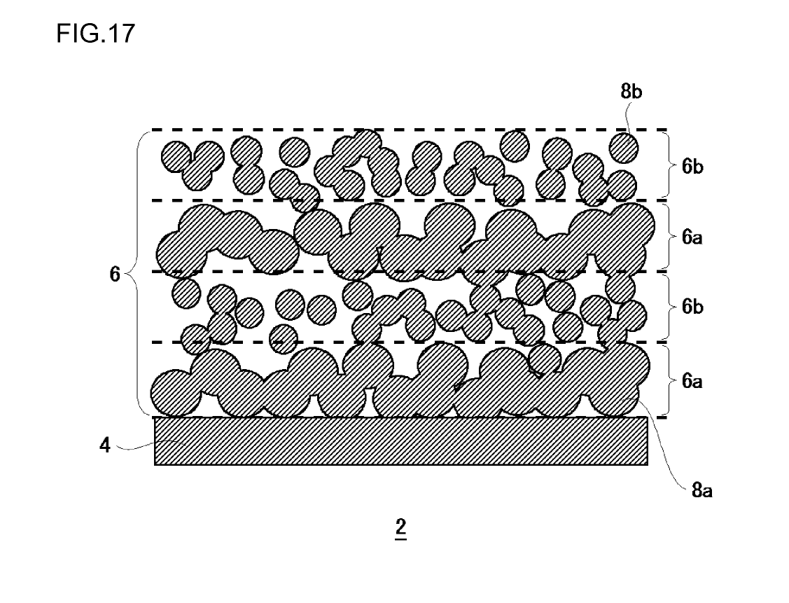

FIG. 17 is a schematic sectional view illustrating a configuration of the positive electrode body of the tenth embodiment. The positive electrode body 2 used in the capacitor of the tenth embodiment includes the positive electrode base material 4 and the porous layer 6. The porous layer 6 has the structure in which the dense layers 6a and the scattered layers 6b are stacked.

The porous layer 6 is formed by coupling metallic particles 8a having relatively large diameters and metallic particles 8b having relatively small diameters. A large proportion of the metallic particles 8a are included in the dense layer 6a rather than the scattered layer 6b, and a large proportion of the metallic particles 8b are included in the scattered layer 6b rather than the dense layer 6a. Accordingly, an average particle diameter of the metallic particles 8 included in the dense layer 6a is larger than an average particle diameter of the metallic particles 8 included in the scattered layer 6b. In other words, most of the dense layer 6a includes the metallic grain aggregate which is formed by coupling the metallic particles 8a having the relatively large diameters, and most of the scattered layer 6b includes the metallic grain aggregate which is formed by coupling the metallic particles 8b having the relatively small diameters. Therefore, the void ratio of the dense layer 6a is lower than the void ratio of the scattered layer 6b when the dense layer 6a is substantially equal to the scattered layer 6b in number density of the metallic particle per unit volume.

The positive electrode body 2 illustrated in FIG. 17 can be formed as follows. For example, using the cold spray apparatus 100 illustrated in FIG. 4, the large-diameter metallic particles 8a are injected from the first nozzle 102, and the small-diameter metallic particles 8b are injected from the second nozzle 112. The dense layer 6a and the scattered layer 6b can be formed by changing the ratio of the amount of metallic particle 8a injected from the first nozzle 102 and the amount of metallic particle 8b injected from the second nozzle 112.

Therefore, according to the configuration of the tenth embodiment, the following effect is obtained in addition to the effects of the sixth embodiment. In the tenth embodiment, the dense layer 6a and the scattered layer 6b are formed using the two types of the metallic particles 8a and 8b having the different diameters. Therefore, the dense layers 6a and the scattered layers 6b can more simply be formed.

### Example

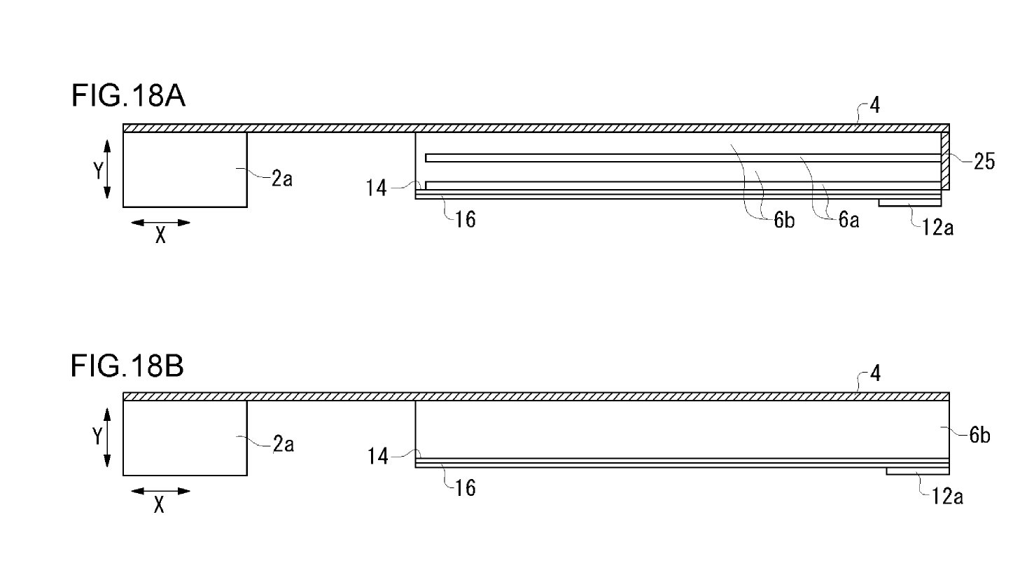

For the purpose of suitable description of the invention, an example of the invention will be described below only by way of example. However, the invention is not limited to the example. FIG. 18A is a schematic sectional view illustrating a simulation model according to an example, and FIG. 18B is a schematic sectional view illustrating a simulation model according to a conventional example.

As illustrated in FIG. 18A, the simulation model of the example has a structure in which a first scattered layer 6b, a first dense layer 6a, a second scattered layer 6b, and a second dense layer 6a are stacked in this order on the surface of the positive electrode base material 4. The conductive polymer layer 14 is stacked on the second dense layer 6a, and the negative electrode base material 16 is stacked on the surface of the conductive polymer layer 14. The carbon paste layer and the silver paste layer, which constitute the negative electrode base material 16, are integrally illustrated in FIG. 18A. A negative electrode terminal 12a is provided at a predetermined position on the surface of the negative electrode base material 16. One end of the positive electrode base material 4 is extended longer than the scattered layer 6b in the lateral direction, and a positive electrode terminal 2a is provided at a leading end of the positive electrode base material 4. The positive electrode terminal 2a is in contact only with the positive electrode base material 4. The other end of the positive electrode base material 4 is connected to a coupling unit 25 which couples the positive electrode base material 4, the dense layer 6a, and the scattered layer 6b. The coupling unit 25 corresponds to the extended unit 24 of the eighth embodiment or the dense unit 26 of the ninth embodiment. A simulation model (Ta) in which the positive electrode base material 4 and the dense layer 6a are made of Ta and a simulation model (Al) in which the positive electrode base material 4 and the dense layer 6a are made of Al are prepared. The scattered layer 6b is made of Ta in both the simulation model (Ta) and the simulation model (Al).

Table 1 illustrates electric conductivity and dimensions of each unit in the simulation model of the example.

TABLE 1

| | Electric | | | |
|---|---|---|---|---|
| | conductivity | | | |
| | σ[S/m] | X[mm] | Y[mm] | Z[mm] |
| Positive electrode | 5 × 10⁶ | 7.3 | 0.1 | 4.0 |
| base material (Ta) | | | | |
| Positive electrode | 5 × 10⁷ | 7.3 | 0.1 | 4.0 |
| base material (Al) | | | | |
| Scattered layer | 5 × 10⁵ | 4.7 | 0.25 | 4.0 |
| Dense layer (Ta) | 5 × 10⁶ | 4.7 | 0.1 | 4.0 |
| Dense layer (Al) | 5 × 10⁷ | 4.7 | 0.1 | 4.0 |
| Conductive polymer | 5 × 10³ | 4.7 | 0.05 | 4.0 |
| layer | | | | |
| Negative electrode | 1 × 10⁶ | 4.7 | 0.05 | 4.0 |
| base material | | | | |

In Table 1, the sign Z designates a direction orthogonal to an X-direction (one of extended directions of each layer) and a Y-direction (thickness direction of each layer), which are illustrated in FIG. 18A.

As illustrated in FIG. 18B, the simulation model of the conventional example has the structure in which the scattered layer 6b is stacked on the surface of the positive electrode base material 4. The conductive polymer layer 14 is stacked on the scattered layer 6b, and the negative electrode base material 16 is stacked on the surface of the conductive polymer layer 14. The carbon paste layer and the silver paste layer, which constitute the negative electrode base material 16, are also integrally illustrated in FIG. 18B. The negative electrode terminal 12a is provided at the predetermined position on the surface of the negative electrode base material 16. One end of the positive electrode base material 4 is extended longer than the scattered layer 6b in the lateral direction, and the positive electrode terminal 2a is provided at the leading end of the positive electrode base material 4. The positive electrode terminal 2a is in contact only with the positive electrode base material 4. A simulation model (Ta) in which the positive electrode base material 4 is made of Ta and a simulation model (Al) in which the positive electrode base material 4 is made of Al are prepared. The scattered layer 6b is made of Ta in both the simulation model (Ta) and the simulation model (Al).

Table 2 illustrates electric conductivity and dimensions of each unit in the simulation model of the conventional example.

TABLE 2

| | Electric | | | |
|---|---|---|---|---|
| | conductivity | | | |
| | σ[S/m] | X[mm] | Y[mm] | Z[mm] |
| Positive electrode | 5 × 10⁶ | 7.3 | 0.1 | 4.0 |
| base material (Ta) | | | | |
| Positive electrode | 5 × 10⁷ | 7.3 | 0.1 | 4.0 |
| base material (Al) | | | | |
| Scattered layer | 5 × 10⁵ | 4.7 | 0.7 | 4.0 |
| Conductive polymer | 5 × 10³ | 4.7 | 0.05 | 4.0 |
| layer | | | | |
| Negative electrode | 1 × 10⁶ | 4.7 | 0.05 | 4.0 |
| base material | | | | |

In Table 2, the sign Z designates the direction orthogonal to the X-direction (one of extended directions of each layer) and the Y-direction (thickness direction of each layer), which are illustrated in FIG. 18B.

A two-dimensional finite element electrolytic simulation is performed using the simulation models. In each simulation model, assuming that the capacitor is used at a high frequency, the electrostatic capacity is set to zero and only the resistance exists. In each simulation model, a contact resistance is omitted, and the positive electrode terminal 2a and the negative electrode terminal 12a have no resistance. As a result of the simulation, the ESR is obtained as the resistance value. Table 3 illustrates the ESR of each simulation model.

TABLE 3

| | | | Conventional |
|---|---|---|---|
| | | Example | example |
| ESR | Simulation model (Ta) | 2.78 | 3.21 |
| [mΩ] | Simulation model (Al) | 1.58 | 1.75 |

Table 3 shows that the simulation model of the example has the ESR lower than that of the simulation model of the conventional example.

The invention is not limited to the above-described embodiments, but various modifications such as design changes can be made based on knowledge of those skilled in the art. It is noted that the embodiment in which the modification is made should be included in the scope of the invention.

In the embodiments, the porous positive electrode body 2 is formed by the cold spray method. Alternatively, the positive electrode body 2 may be formed using well-known technologies, such as an aerosol deposition method and a powder jet method, in which the film is formed by spraying the particles in a non-melted state at high speed. The porous positive electrode body 2 can also be formed by these methods.

In the embodiments, the tantalum foil is used as the positive electrode base material 4. Alternatively, a film-like structure in which the plural metallic particles 8 are coupled may be used as the positive electrode base material 4. At this point, the positive electrode base material 4 can be formed as follows. The metallic particles 8 are sprayed onto a plate member to form the film of the metallic particles 8 on the surface of the plate member by the cold spray method. Then the positive electrode base material 4 including the metallic grain aggregate in which the metallic particles 8 are coupled can be formed by removing the plate member.

Alternatively, the positive electrode body 2 may be formed by forming the metallic particles 8 under pressure and sintering the formed particles. When the positive electrode body 2 is formed by the sintering, the pressure in the pressure forming, a sintering temperature, and the particle diameter of the metallic particle 8 are adjusted while the pressure forming and the sintering of the metallic particles 8 are repeatedly performed plural times, which allows the dense layer 6a and the scattered layer 6b to be formed.

In the sixth and seventh embodiments, the tantalum foil is used as the positive electrode base material 4. Alternatively, a lead wire made of the valve metal may be used as the positive electrode base material 4. At this point, the lead wire is rotated about an axis thereof, and the metallic particles 8 are sprayed around the axis of the lead wire, which allows the porous layer 6 to be formed.

It is conceivable that the invention has the following configurations.

The capacitor electrode body in which the connection unit is the extended unit in which part of the base material is extended in the direction in which the dense layer and the scattered layer are stacked.

The capacitor electrode body in which the connection unit is the dense unit having the void ratio lower than that of other regions in the scattered layer in the lateral of the scattered layer. At this point, the connection unit may include the extended unit and the dense unit.

A capacitor electrode body producing method of spraying the metallic particles onto the base material to form the porous layer in the electrode body forming process.

The capacitor producing method including the process of preparing the capacitor electrode body formed by the above-described producing method as the positive electrode body, the process of oxidizing the surface of the positive electrode body to form the dielectric layer, and the process of forming the negative electrode body such that the surface of the dielectric layer is covered therewith.

### DESCRIPTION OF SIGNS AND NUMERALS

1 capacitor, 2 positive electrode body, 4 positive electrode base material, 5 composite layer, 5a composite dense layer, 5b composite scattered layer, 6 porous layer, 6a dense layer, 6b scattered layer, 8, 8a, 8b metallic particle, 9 gap, 10 dielectric layer, 12 negative electrode body, 14 conductive polymer layer, 16 negative electrode base material, 16a carbon paste layer, 16b silver paste layer, 18 organic particle, 20 composite particle, 21 composite particle, extended unit, 26 dense unit, 100 cold spray apparatus, 101 base material grasping unit, 102 first nozzle, 104 first material supply unit, 106 gas supply unit, 108 first heater, 112 second nozzle, 114 second material supply unit, 118 second heater

The invention can be applied to the capacitor electrode body.

1. A capacitor electrode body producing method comprising forming a porous electrode body by spraying an organic particle and a metallic particle made of at least one of a valve metal and an alloy thereof onto a base material made of at least one of the valve metal and the alloy thereof.

2. The capacitor electrode body producing method according to claim 1, wherein
the metallic particle and the organic particle are simultaneously sprayed from different nozzles in the electrode body forming step.

3. The capacitor electrode body producing method according to claim 1, wherein
the metallic particle and the organic particle are alternately sprayed from different nozzles in the electrode body forming step.

4. The capacitor electrode body producing method according to claim 1, wherein
the metallic particle and the organic particle are sprayed as a composite particle of the metallic particle and the organic particle in the electrode body forming step.

5. The capacitor electrode body producing method according to claim 1, further comprising removing the organic particle sprayed onto the base material after the electrode body forming step.

6. The capacitor electrode body producing method according to claim 1, wherein
the organic particle has a conductive property.

7. A capacitor producing method comprising:
preparing the capacitor electrode body formed by the producing method according to claim 1 as a positive electrode body;
oxidizing a surface of the positive electrode body to form a dielectric layer; and
forming a negative electrode body such that a surface of the dielectric layer is covered therewith.

8. A capacitor electrode body comprising:
a base material which is made of a conductive material; and
a porous layer which is provided on the base material to include at least each one of a dense layer and a scattered layer, the dense layer including a metallic grain aggregate made of at least one of a valve metal and an alloy thereof, the scattered layer including the metallic grain aggregate made of at least one of the valve metal and the alloy thereof, the scattered layer having a void ratio higher than that of the dense layer.

9. The capacitor electrode body according to claim 8, wherein
the plurality of dense layers and the plurality of scattered layers are alternately stacked on the base material.

10. The capacitor electrode body according to claim 8, further comprising a connection unit with which the dense layers or the dense layer and the base material are in contact, wherein the connection unit has electric resistivity lower than that of the scattered layer.

11. A capacitor comprising:
a positive electrode body which includes the capacitor electrode body according to claim 8;
a dielectric layer which is formed on a surface of the positive electrode body; and
a negative electrode body which is formed such that a surface of the dielectric layer is covered therewith.

12. A capacitor electrode body producing method comprising providing a porous layer including a metallic grain aggregate made of at least one of a valve metal and an alloy thereof onto a base material made of a conductive material to form an electrode body, wherein
a dense layer having a relatively low void ratio and a scattered layer having a relatively high void ratio are stacked to form the porous layer in the electrode body forming step.

13. The capacitor electrode body producing method according to claim 12, wherein
the plurality of dense layers and the plurality of scattered layers are alternately stacked to form the porous layer in the electrode body forming step.
